(19) United States
(12) Patent Application Publication
(10) Pub. No.: US 2021/0161146 A1
(43) Pub. Date: Jun. 3, 2021

(54) COMPOSITIONS AND METHODS FOR INHIBITING PATHOGENS ON PLANTS

(71) Applicant: CH2O INCORPORATED, Olympia, WA (US)

(72) Inventor: Carl E. Iverson, Olympia, WA (US)

(21) Appl. No.: 15/734,179

(22) PCT Filed: May 31, 2019
(86) PCT No.: PCT/US19/35083

§ 371 Date: Dec. 1, 2020

Related U.S. Application Data
(60) Provisional application No. 62/679,613, filed on Jun. 1, 2018.

(51) Int. Cl. A01N 59/00; A01N 57/20

(52) U.S. Cl. CPC A01N 59/00; A01N 57/20

(57) ABSTRACT

This disclosure describes compositions and methods for inhibiting pathogens on plants.

### BACKGROUND

Every year, crops are damaged by plant pathogens, such as viruses and bacteria. Treatments to kill or prevent the spread of pathogens are not always successful. In some cases, entire fields can be decimated. Fire blight, caused by the bacterium Erwinia amylovora, is an especially virulent disease that can spread rapidly among apple, pear, and quince trees. Antibiotic treatments are common, but not always effective. An effective, non-toxic treatment that kills or suppresses pathogens on plants is needed.

### SUMMARY

In one aspect, methods for treating plants are provided. Such methods typically includes, in a growing season, contacting above-ground portions of flowering plants with an aqueous solution comprising a plant pathogen-inhibiting agent, wherein the plant pathogen-inhibiting agent comprises at least one of chlorite, chlorate, chlorine dioxide, or a phosphonate, and a total concentration of the plant pathogen-inhibiting agent in the aqueous solution is sufficient to: kill, suppress, or substantially reduce the amount of plant pathogens on the above-ground portions of the flowering plants, inhibit growth of plant pathogens on the above-ground portions of the flowering plants, or inhibit spread of plant pathogens on each of the flowering plants or from a first one of the flowering plants to a second one of the flowering plants.

In another aspect, methods for treating plants are provided. Such methods typically include, in a growing season, contacting above-ground portions of flowering plants with a first aqueous solution and a second aqueous solution or a mixture thereof, wherein the first aqueous solution comprises chlorite, the second aqueous solution comprises an acid, and the mixture of the first aqueous solution and the second aqueous solution comprises chlorine dioxide in a concentration sufficient to: kill, suppress, or substantially reduce the amount of pathogens on the above-ground portions of the flowering plants, inhibit growth of pathogens on the above-ground portions of the flowering plants, or inhibit spread of pathogens on each of the flowering plants or from a first one of the flowering plants to a second one of the flowering plants.

In one embodiment, the pathogen-inhibiting agent or first and/or second aqueous solution(s) comprises, consists of, or consists essentially of chlorite. In one embodiment, a concentration of the chlorite in the aqueous solution or first and/or second aqueous solution(s) is at least 25 parts per million by weight. In one embodiment, a concentration of the chlorite in the aqueous solution or first and/or second aqueous solution(s) is in a range of 1 part per million by weight to 200 parts per million by weight. In one embodiment, a concentration of the chlorite in the aqueous solution or first and/or second aqueous solution(s) is in a range of 1 part per million by weight to 1000 parts per million by weight.

In one embodiment, the pathogen-inhibiting agent comprises, consists of, or consists essentially of a phosphonate. In one embodiment, the phosphonate comprises at least one of phosphonobutane-1,2,4-tricarboxylic acid and 1-hydroxyethane 1,1-diphosphonic acid. In one embodiment, a concentration of the phosphonate in the aqueous solution or first and/or second aqueous solution(s) is at least 25 parts per million by weight. In one embodiment, a concentration of the phosphonate is in a range of 0.1 parts per million by weight to 50 parts per million by weight. In one embodiment, the pathogen-inhibiting agent comprises, consists of, or consists essentially of chlorite and a phosphonate.

In one embodiment, the pathogen-inhibiting agent comprises, consists of, or consists essentially of chlorine dioxide. In one embodiment, a concentration of the chlorine dioxide in the aqueous solution or first and/or second aqueous solution(s) is at least 0.05 parts per million by weight. In one embodiment, a concentration of chlorine dioxide in the aqueous solution or first and/or second aqueous solution(s) is at least 2 parts per million by weight. In one embodiment, a concentration of chlorine dioxide in the aqueous solution or first and/or second aqueous solution(s) is at least 5 parts per million by weight. In one embodiment, a concentration of chlorine dioxide in the aqueous solution or first and/or second aqueous solution(s) is 25 parts per million by weight or less. In one embodiment, a concentration of chlorine dioxide in the aqueous solution or first and/or second aqueous solution(s) is 30 parts per million by weight or less.

In one embodiment, the pathogen-inhibiting agent comprises, consists of, or consists essentially of chlorine dioxide and chlorite.

In one embodiment, the pathogen-inhibiting agent comprises, consists of, or consists essentially of chlorine dioxide, chlorite, and a phosphonate.

In one embodiment, the pathogen-inhibiting agent comprises, consists of, or consists essentially of a phosphonate. In one embodiment, the phosphonate comprises at least one of phosphonobutane-1,2,4-tricarboxylic acid and 1-hydroxyethane 1,1-diphosphonic acid.

In one embodiment, the pathogen-inhibiting agent comprises, consists of, or consists essentially of chlorite, chlorate, and chlorine dioxide. In one embodiment, a total concentration of the chlorite, the chlorate, and the chlorine dioxide in the aqueous solution or first and/or second aqueous solution(s) is at least 25 parts per million by weight. In one embodiment, a concentration of chlorite, the chlorate, and the chlorine dioxide in the aqueous solution or first and/or second aqueous solution(s) is in a range of 1 part per million by weight to 200 parts per million by weight. In one embodiment, a concentration of chlorite, the chlorate, and the chlorine dioxide in the aqueous solution or first and/or second aqueous solution(s) is in a range of 1 part per million by weight to 200 parts per million by weight. In one embodiment, a concentration of chlorite, the chlorate, and the chlorine dioxide in the aqueous solution or first and/or second aqueous solution(s) is in a range of 1 part per million by weight to 1000 parts per million by weight.

In one embodiment, contacting the above-ground portions of the flowering plants comprises contacting leaves of the flowering plants. In one embodiment, the flowering plants are trees, and contacting the above-ground portions of the flowering plants comprises contacting at least one of the branches, trunk, and bark of the tree. In one embodiment, contacting the above-ground portions of the flowering plants with the aqueous solution occurs before blooms are formed on the flowering plants.

In one embodiment, the aqueous solution is a first aqueous solution and further comprising, in the growing season, contacting the above-ground portions of the flowering plants with a second aqueous solution comprising a second pathogen-inhibiting agent, wherein a concentration of the second pathogen-inhibiting agent in the second aqueous solution is sufficient to kill, suppress, or substantially reduce the amount of pathogens on the flowering plants.

In one embodiment, the second pathogen-inhibiting agent comprises, consists of, or consists essentially of chlorite.

In one embodiment, the second pathogen-inhibiting agent comprises, consists of, or consists essentially of a phosphonate. In one embodiment, the phosphonate comprises at least one of phosphonobutane-1,2,4-tricarboxylic acid and 1-hydroxyethane 1,1-diphosphonic acid.

In one embodiment, the second pathogen-inhibiting agent comprises, consists of, or consists essentially of, chlorite and a phosphonate.

In one embodiment, the second pathogen-inhibiting agent comprises, consists of, or consists essentially of chlorine dioxide.

In one embodiment, the second pathogen-inhibiting agent comprises, consists of, or consists essentially of chlorine dioxide and chlorite.

In one embodiment, the second pathogen-inhibiting agent comprises, consists of, or consists essentially of, chlorine dioxide, chlorite, and a phosphonate.

In one embodiment, contacting the above-ground portions of the flowering plants with the second aqueous solution occurs after blooms are formed on the flowering plants. In one embodiment, contacting the above-ground portions of the flowering plants with the second aqueous solution occurs at least five days after contacting the above-ground portions of the flowering plants with the first aqueous solution. In one embodiment, the flowering plants are growing in an environment having an ambient temperature of at least 50° F. at the time of the contacting. In one embodiment, the flowering plants are growing in an environment having an ambient temperature of at least 75° F. at the time of the contacting. In one embodiment, the flowering plants are in an environment having an ambient temperature of less than 90° F. at the time of the contacting.

In one embodiment, contacting the above-ground portions of the flowering plants with the aqueous solution comprises misting the above-ground portions with the aqueous solution. In one embodiment, contacting the above-ground portions of the flowering plants with the aqueous solution comprises coating the above-ground portions with the aqueous solution. In one embodiment, contacting the above-ground portions of the flowering plants with the aqueous solution comprises drenching the flowering plants with the aqueous solution. In one embodiment, contacting the above-ground portions of the flowering plants with the aqueous solution comprises dispensing the aqueous solution from above the flowering plants toward the ground. In one embodiment, contacting the above-ground portions of the flowering plants with the aqueous solution comprises dispensing the aqueous solution or first and/or second aqueous solution(s) from a dispenser elevated above the ground and from one side of the flowering plants toward another side of the flowering plants.

In one embodiment, the pathogen comprises a species of bacteria. In one embodiment, the bacteria comprises Erwinia amylovora. In one embodiment, the method for treating plants is a foliar treatment method.

In another aspect, methods of applying an aqueous solution of ClO2 to a plant are provided. Such methods typically include spraying (or atomizing) the plant with an aqueous solution of ClO2 in the presence of a fan or a blower, wherein the fan or the blower moves an amount of air sufficient to liberate at least some of the ClO2 from the aqueous solution. In one embodiment, the liberation occurs before the aqueous solution contacts the plant. In one embodiment, the liberation occurs after the aqueous solution contacts the plant. In one embodiment, at least 10% of the ClO2 is liberated from the aqueous solution.

### DETAILED DESCRIPTION OF THE DRAWINGS

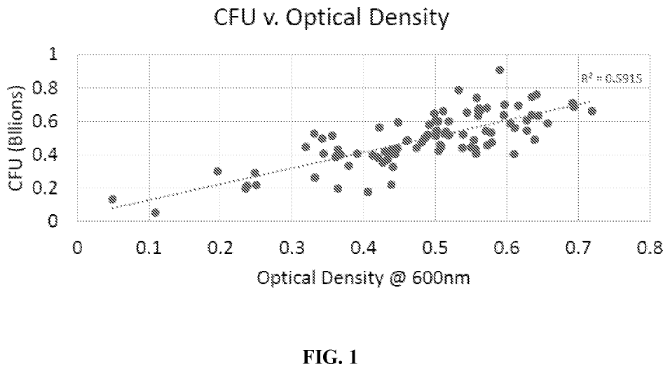

FIG. 1 is a graph showing the optical density measured at 600nm plotted against CFU. The trend line is provided for demonstration of a linear correlation.

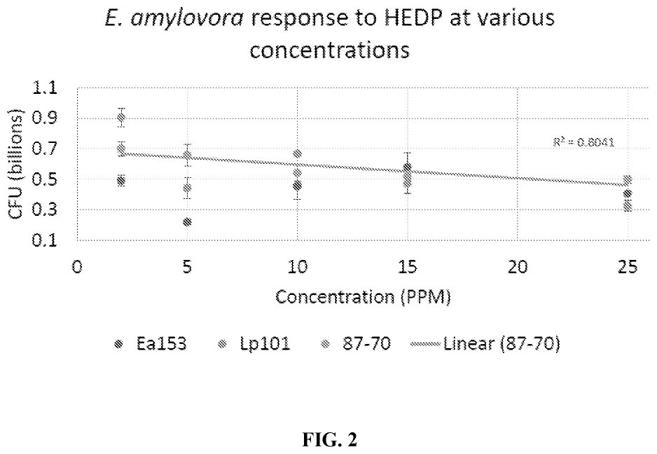

FIG. 2 is a graph showing the colony forming units (CFU) plotted against concentration (ppm) of reagent HEDP. The trend line is provided for depiction of a linear correlation among the most responsive pathovar within the treatment regimen. Error bars depicting standard error among replicates are provided for each data point.

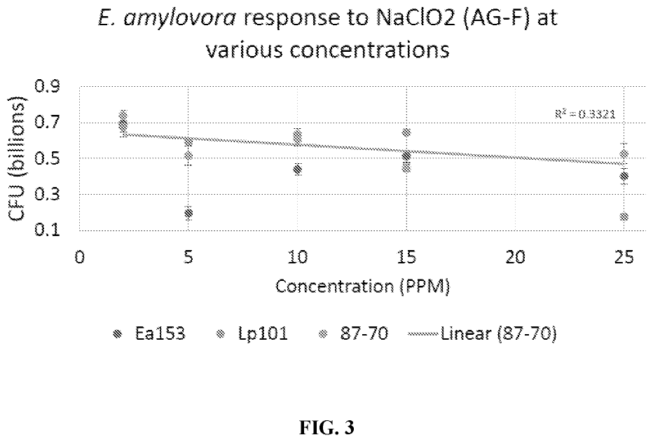

FIG. 3 is a graph showing the colony forming units (CFU) plotted against concentration (PPM) of reagent NaClO2 (8.5% 60% active HEDPA, 12.5% 45% active potassium hydroxide, 40% 25% active sodium chlorite, and 39% water, all by weight). The trend line is provided for depiction of a linear correlation among the most responsive pathovar within the treatment regimen. Error bars depicting standard error among replicates are provided for each data point.

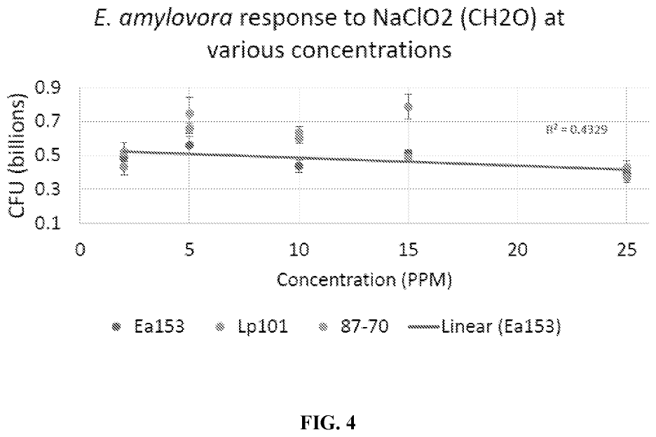

FIG. 4 is a graph showing the colony forming units (CFU) plotted against concentration (PPM) of reagent NaClO2 (CH2O). The trend line is provided for depiction of a linear correlation among the most responsive pathovar within the treatment regimen. Error bars depicting standard error among replicates are provided for each data point.

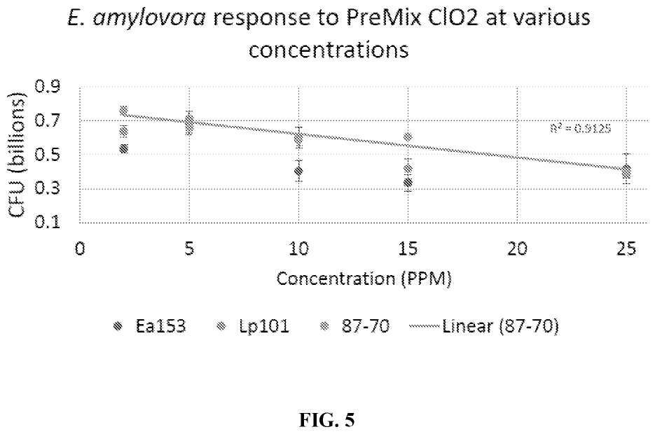

FIG. 5 is a graph showing colony forming units (CFU) plotted against concentration (PPM) of reagent PreMix ClO2. The trend line is provided for depiction of a linear correlation among the most responsive pathovar within the treatment regimen. Error bars depicting standard error among replicates are provided for each data point.

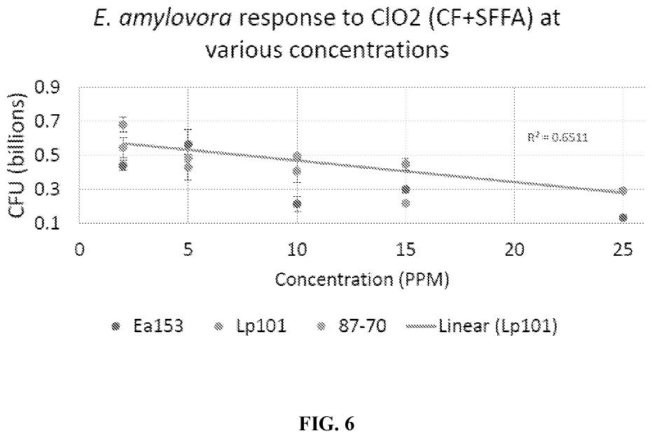

FIG. 6 is a graph showing colony forming units (CFU) plotted against concentration (PPM) of reagent ClO2 (Clean Finish and Sure Flow). The trend line is provided for depiction of a linear correlation among the most responsive pathovar within the treatment regimen. Error bars depicting standard error among replicates are provided for each data point.

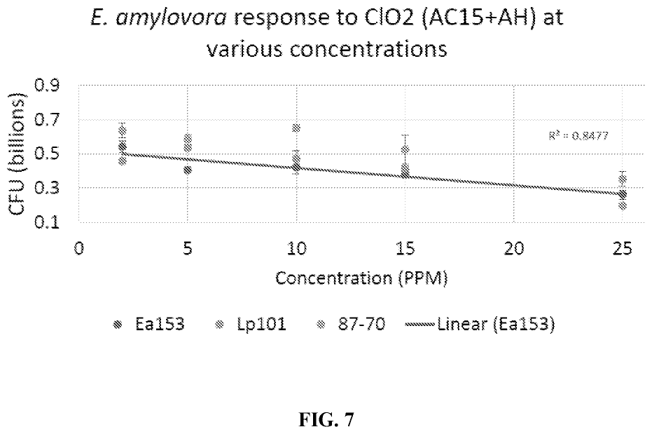

FIG. 7 is a graph showing colony forming units (CFU) plotted against concentration (PPM) of reagent ClO2 (Aqua Clear 15 and Activator H). The trend line is provided for depiction of a linear correlation among the most responsive pathovar within the treatment regimen. Error bars depicting standard error among replicates are provided for each data point.

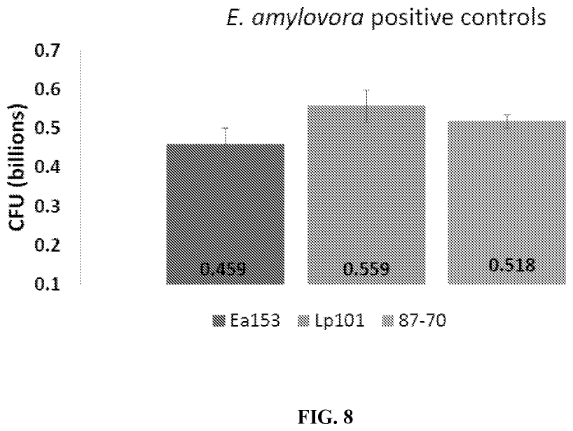

FIG. 8 is a graph showing the average CFUs of three E. amylovora pathovars (Ea153, Lp101, 87-70) when grown in pure LB broth powder suspended in sterile ddH2O. Error bars depicting standard error among replicates are provided for each pathovar.

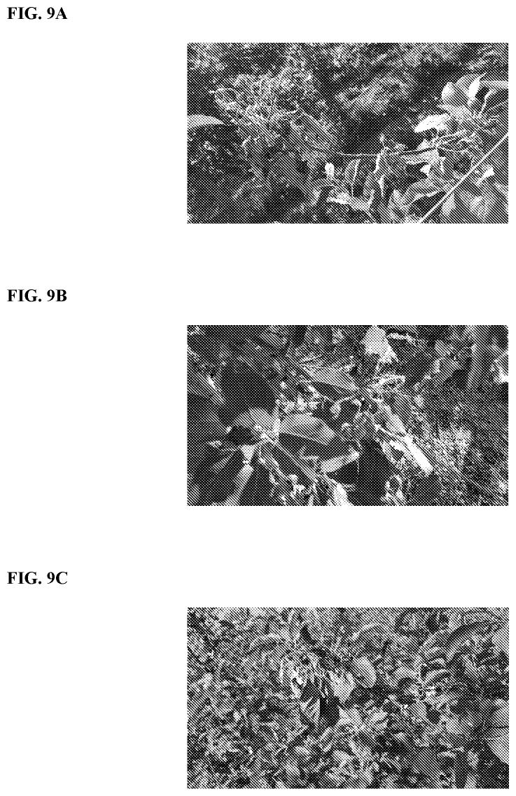

FIG. 9A-C are photographs of leaves from blight-infected apple trees.

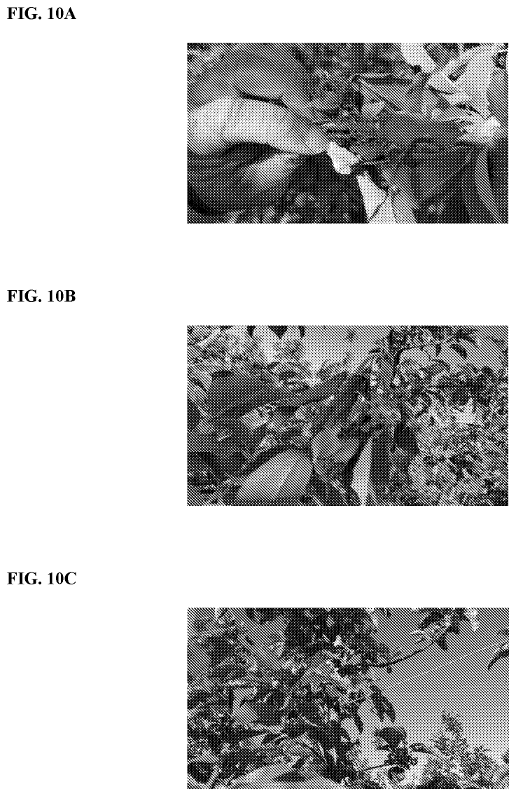

FIG. 10A-C are photographs of leaves from blight-infected apple trees (e.g., shown in FIG. 9A-C) following treatment with, respectively, 2 ppm, 10 ppm, and 25 ppm ClO4.

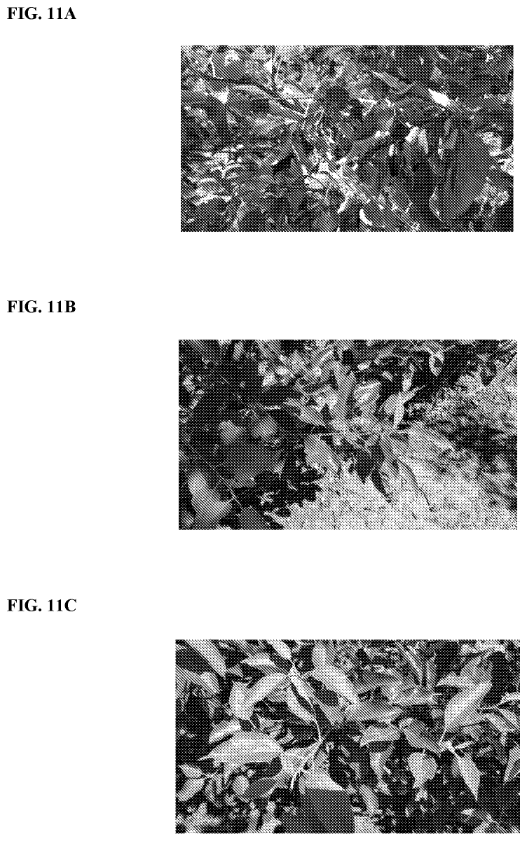

FIG. 11A is a photograph of leaves from blight-infected apple trees.

FIG. 11B-C are photographs of leaves from blight-infected apple trees (e.g., shown in FIG. 11A) following treatment with ClO4.

### DETAILED DESCRIPTION

Methods and compositions are described herein that can be used to inhibit plant pathogens on their host plants. Methods and compositions also are described herein that can be used to suppress or control plant disease on a plant. For example, the methods and compositions described herein can be used to inhibit any number of bacterial or fungal pathogens that infect agricultural crops such as, without limitation, grains, herbs, spices, row crops, berries (e.g., blueberries, raspberries), fruit and nut trees, citrus trees (e.g., oranges, grapefruit, tangelos), vines (e.g., grapes and hops), and tobacco or cannabis. For example, the methods and compositions described herein can be used to suppress or control plant diseases such as, without limitation, bacterial blight, black spot, botrytis (or gray mold), brown spot, copper spot, dollar spot, early and late blights, fusarium, powdery mildew, downy mildews, or scabs on host plants.

The methods and compositions described herein can be used to prevent infection (e.g., preventative treatment) or to treat or cure an infected or diseased plant (e.g., curative treatment). As used herein, inhibiting plant pathogens on their host refers to reducing or decreasing the number of pathogens on the plant, lessening the amount of infection in or on the plant, slowing the rate of growth of the pathogen or rate of infection of the plant, or weakening the infectivity or virulence of the pathogen.

In a first general aspect, treating plants includes, in a growing season, contacting above-ground portions of plants with an aqueous solution including a pathogen-inhibiting agent. The plants can be flowering plants that bear food. The pathogen inhibiting agent includes at least one of chlorite, chlorate, chlorine dioxide, or a phosphonate. A total concentration of the pathogen-inhibiting agent in the aqueous solution can be sufficient to kill, suppress, or substantially reduce the amount of pathogens on the above-ground portions of the flowering plants, inhibit growth of pathogens on the above-ground portions of the flowering plants, or inhibit spread of pathogens on each of the flowering plants or from a first one of the flowering plants to a second one of the flowering plants. The total concentration of the pathogen inhibiting agent, however, is not phytotoxic. As used herein, phytotoxic refers to any type of toxicity to the plant and can include, for example, chemical burning, poisoning, and interference with plant physiology or functioning. In some cases, the aqueous solution is a first aqueous solution, and treating the plants includes, in the growing season, contacting the above-ground portions of the flowering plants with a second aqueous solution including a second pathogen-inhibiting agent. The second pathogen-inhibiting agent includes at least one of chlorite, chlorate, chlorine dioxide, or a phosphonate, and total concentration of the second pathogen-inhibiting agent in the second aqueous solution is sufficient to kill, suppress, or substantially reduce the amount of pathogens on the above-ground portions of the flowering plants, inhibit growth of pathogens on the above-ground portions of the flowering plants, or inhibit spread of pathogens on each of the flowering plants or from a first one of the flowering plants to a second one of the flowering plants.

Implementations of the first general aspect may include one or more of the following features. “Pathogen-inhibiting agent” refers to the first pathogen-inhibiting agent or the second pathogen-inhibiting agent. The first pathogen-inhibiting agent and the second pathogen-inhibiting agent may be the same or different.

In some implementations, the pathogen-inhibiting agent includes, consists of, or consists essentially of chlorite. As used herein, “consists essentially of” means at least 90% by weight. A concentration of the chlorite in the aqueous solution may be at least 25 parts per million by weight (ppm), in a range of 1 ppm to 200 ppm, or in a range of 1 ppm to 1000 ppm. In some implementations, the pathogen-inhibiting agent includes, consists of, or consists essentially of a phosphonate. The phosphonate may include at least one of phosphonobutane-1,2,4-tricarboxylic acid and 1-hydroxyethane 1,1-diphosphonic acid. A concentration of the phosphonate in the aqueous solution is typically in a range of 0.1 ppm to 50 ppm.

In some implementations, the pathogen-inhibiting agent includes, consists of, or consists essentially of, chlorite and a phosphonate.

In some implementations, the pathogen-inhibiting agent includes, consists of, or consists essentially of chlorine dioxide. A concentration of the chlorine dioxide in the aqueous solution may be at least 0.05 ppm, at least 2 ppm, or at least 5 ppm. In some cases, a concentration of the chlorine dioxide in the aqueous solution may be 25 ppm or less or 30 ppm or less.

In some implementations, the pathogen-inhibiting agent includes, consists of, or consists essentially of chlorine dioxide and chlorite. In some implementations, the pathogen inhibiting agent includes, consists of, or consists essentially of chlorine dioxide, chlorite, or a phosphonate. In some implementations, the pathogen-inhibiting agent includes, consists of, or consists essentially of a phosphonate. The phosphonate may include at least one of phosphonobutane-1,2,4-tricarboxylic acid and 1-hydroxyethane 1,1-diphosphonic acid.

In some implementations, the pathogen-inhibiting agent includes, consists of, or consists essentially of chlorite, chlorate, and chlorine dioxide. A total concentration of the chlorite, the chlorate, and the chlorine dioxide in the aqueous solution is at least 25 ppm, in a range of 1 ppm to 200 ppm, or in a range of 1 ppm to 1000 ppm.

Contacting the above-ground portions of the flowering plants can include contacting leaves of the flowering plants. When contacting the above-ground portions of the flowering plants includes contacting the leaves of the flowering plants with the aqueous solution, treating the plants may be referred to as a foliar treatment. In some cases, the flowering plants are trees, and contacting the above-ground portions of the flowering plants includes contacting branches, bark, or trunks of the trees.

Contacting the above-ground portions of the flowering plants with the aqueous solution typically occurs before blooms are formed on the flowering plants. In some cases, contacting the above-ground portions of the flowering plants with the aqueous solution occurs after blooms are formed on the flowering plants. In certain cases, contacting the above-ground portions of the flowering plants with the aqueous solution occurs before blooms are formed on the flowering plants, and the above-ground portions of the flowering plants are contacted with a second or subsequent aqueous solution after blooms are formed on the flowering plants. That is, the flowering plants may be treated sequentially with more than one aqueous solution (e.g., the aqueous solution is a first aqueous solution, and treating the plants includes, after contacting the above-ground portions of the flowering plants with the first aqueous solution, contacting the above-ground portions of the flowering plants with a second or subsequent aqueous solution). The second or subsequent aqueous solution may be the same as or different than the first aqueous solution (e.g., in composition or concentration). In some cases, the second aqueous solution is a mixture of two or more aqueous solutions. The mixture may be formed before contacting the above-ground portions of the flowering plants with the second aqueous solution, or formed during contacting the above-ground portions of the flowering plants with the two or more aqueous solutions.

Contacting the above-ground portions of the flowering plants with the first aqueous solution may occur before blooms are formed on the flowering plants, and contacting the above-ground portions of the flowering plants with the second aqueous solution may occur after blooms are formed on the flowering plants. In some cases, contacting the above-ground portions of the flowering plants with the second aqueous solution occurs at least one, two, three, four, five, six, or seven days after contacting the above-ground portions of the flowering plants with the first aqueous solution. In some cases, contacting the above-ground portions of the flowering plants with the second aqueous solution occurs a week or more after contacting the above-ground portions of the flowering plants with the first aqueous solution.

At the time of contacting the above-ground portions of the flowering plants with the first aqueous solution, the second aqueous solution, or both, the flowering plants may be growing in an environment with an ambient temperature of at least 50° F. or at least 75° F. An ambient temperature of the environment is typically less than 90° F. at the time of the contacting, but the ambient temperature may be higher than 90° F.

Contacting the above-ground portions of the flowering plants with the first aqueous solution, the second aqueous solution, or both may include misting, spraying, coating, or drenching the above-ground portions with the aqueous solution. In some cases, contacting the above-ground portions of the flowering plants with the first aqueous solution, the second aqueous solution, or both includes dispensing the solution from above the flowering plants toward the ground, or from a dispenser elevated above the ground and from one side of the flowering plants toward another side of the flowering plants. This process may be repeated such that all sides of flowering plants or entire flowering plants are contacted with the aqueous solution.

Based on the type of flowering plant being treated, the quantity of flowering plants being treated, and the method of applying the treatment, the first aqueous solution, the second aqueous solution, or both may be applied at a rate of 5 gallons per minute (gpm) to 5000 gpm, 5 gpm to 1000 gpm, 5 gpm to 500 gpm, 5 gpm to 150 gpm, 5 gpm to 100 gpm, 5 gpm to 50 gpm, 10 gpm to 40 gpm, or 20 gpm to 30 gpm. In some cases, the first aqueous solution, the second aqueous solution, or both may be applied at a rate of 200 gpm, 250 gpm, 500 gpm, 1000 gpm, 1500 gpm, 2000 gpm, 2500 gmp, or higher. It would be appreciated that the flow rate can be dependent, at least in part, on the number of plants being treated. In some cases, the first aqueous solution, the second aqueous solution, or both may be applied for a length of time between about 10 seconds and about 2 hours, based at least in part on the flow rate of the application.

Typical pathogens include viruses, bacteria, and fungi. In some cases, the pathogen is a bacteria, such as Erwinia amylovora, the causative agent of blight, the flowering plants are trees, such as fruit trees (e.g., apple trees, pear trees), palm trees, citrus trees, or nut trees, and a concentration of the chlorine dioxide in the first aqueous solution, the second aqueous solution, or both is sufficient to kill, suppress, or substantially reduce the amount of the Erwinia amylovora on above-ground portions (e.g., leaves, branches, bark, trunk) of the trees, to inhibit growth of the Erwinia amylovora on the above-ground portions of the trees, or to inhibit spread of the Erwinia amylovora on each of the trees or from a first tree to a second tree. In some instances, severely infected trees can exhibit little to no symptoms of blight (e.g., weeping from the tree trunk and discolored leaves) following application of one or more aqueous solutions as described herein.

In some cases, the pathogen is a virus, such as Red Blotch Virus (Grablovirus or GRBav), the flowering plants are grape vines, and a concentration of the chlorine dioxide in the first aqueous solution, the second aqueous solution, or both is sufficient to kill, suppress, or substantially reduce the amount of the GRBav on above-ground portions (e.g., leaves, branches) of the vines, to inhibit growth of the virus on the above-ground portions of the vines, or to inhibit spread of the virus on the vines or from a first vine to a second vine.

In some cases, the pathogen is powdery mildew, the flowering plants are trees, such as fruit trees (e.g., apple trees, pear trees), palm trees, citrus trees, or nut trees, and a concentration of the chlorine dioxide in the first aqueous solution, the second aqueous solution, or both is sufficient to kill, suppress, or substantially reduce the amount of the powdery mildew on above-ground portions (e.g., leaves, branches) of the trees, to inhibit growth of the powdery mildew on the above-ground portions of the trees, or to inhibit spread of the powdery mildew on the trees or from a first tree to a second tree.

In some cases, the pathogen is citrus canker, the flowering plants are trees, such as citrus trees (e.g., orange trees, lemon trees), and a concentration of the chlorine dioxide in the first aqueous solution, the second aqueous solution, or both is sufficient to kill, suppress, or substantially reduce the amount of the citrus canker on above-ground portions (e.g., leaves, branches) of the trees, to inhibit growth of the citrus canker on the above-ground portions of the trees, or to inhibit spread of the citrus canker on the trees or from a first tree to a second tree.

In a second general aspect, treating plants includes, in a growing season, contacting above-ground portions of flowering plants with a first aqueous solution and a second aqueous solution or a mixture of a first aqueous solution and a second aqueous solution, where the first aqueous solution includes chlorite, the second aqueous solution includes an acid, and the mixture of the first aqueous solution and the second aqueous solution includes chlorine dioxide in a concentration sufficient to kill, suppress, or substantially reduce the amount of pathogens on the above-ground portions of the flowering plants, to inhibit growth of pathogens on the above-ground portions of the flowering plants, or to inhibit spread of pathogens on each of the flowering plants or from a first one of the flowering plants to a second one of the flowering plants. The total concentration of the chlorine dioxide, however, is not phytotoxic. For conciseness, the first solution and the second solution and the mixture of the first solution and the second solution are referred to collectively here as “the first treatment.”

Implementations of the second general aspect may include one or more of the following features.

Some implementations include, in the growing season, contacting the above-ground portions of the flowering plants with a third aqueous solution and a fourth aqueous solution or a mixture thereof, wherein the third aqueous solution comprises chlorite, the fourth aqueous solution comprises an acid, and the mixture of the third aqueous solution and the fourth aqueous solution comprises chlorine dioxide in a concentration sufficient to kill, suppress, or substantially reduce the amount of pathogens on the above-ground portions of the flowering plants. For conciseness, the third solution and the fourth solution are referred to collectively here as “the second treatment.” The third and fourth aqueous solutions may be the same as or different than the first and second aqueous solutions, respectively, with regard to composition, concentration, time of application.

Contacting the above-ground portions of the flowering plants with the second treatment may occur after blooms are formed on the flowering plants. In some cases, contacting the above-ground portions of the flowering plants with the second treatment occurs at least five days after contacting the above-ground portions of the flowering plants with the first treatment.

Contacting above-ground portions of flowering plants with a first aqueous solution and a second aqueous solution typically results in reaction of the chlorite and the acid to yield chlorine dioxide. Formation of the chlorine dioxide may occur before, during, or after contacting the flowering plant with the first treatment. The first aqueous solution and the second aqueous solution may be applied sequentially in any order (e.g., the first aqueous solution and then the second aqueous solution, or the second aqueous solution and then the first aqueous solution), such that chlorine dioxide is formed when the first and second aqueous solutions mix on the plants. In some cases, the first aqueous solution and the second aqueous solution are applied simultaneously, or the application of the first aqueous solution and the second aqueous solution may overlap in time. In certain cases, a length of time may pass between application of the first aqueous solution and application of the second aqueous solution. The length of time may range from a seconds to minutes or longer. In some cases, a length of time between application of the first aqueous solution and the second aqueous solution is of sufficient length for first-applied aqueous solution to dry before application of the second-applied aqueous solution. In certain cases, the second aqueous solution is applied before the first aqueous solution has dried.

Contacting the above-ground portions of the flowering plants can include contacting leaves of the flowering plants. When contacting the above-ground portions of the flowering plants includes contacting the leaves of the flowering plants with the first treatment, treating the plant may be referred to as a foliar treatment. In some cases, the flowering plants are trees, and contacting the above-ground portions of the flowering plants includes contacting branches, bark, or trunks of the trees.

Contacting the above-ground portions of the flowering plants with the first treatment typically occurs before blooms are formed on the flowering plants. In some cases, contacting the above-ground portions of the flowering plants with the first treatment occurs after blooms are formed on the flowering plants. In certain cases, contacting the above-ground portions of the flowering plants with the first treatment occurs before blooms are formed on the flowering plants, and the above-ground portions of the flowering plants are contacted with a second or subsequent treatment after blooms are formed on the flowering plants. That is, after contacting the above-ground portions of the flowering plants with the first treatment, the above-ground portions of the flowering plants may be contacted with a second or subsequent treatment. The second or subsequent treatment may be the same as or different than the first treatment (e.g., in composition or concentration of solutions, or duration of the application of the solutions).

Contacting the above-ground portions of the flowering plants with the first treatment may occur before blooms are formed on the flowering plants, and contacting the above-ground portions of the flowering plants with the second treatment may occur after blooms are formed on the flowering plants. In some cases, contacting the above-ground portions of the flowering plants with the second treatment occurs at least one, two, three, four, five, six, or seven days after contacting the above-ground portions of the flowering plants with the first treatment. In some cases, contacting the above-ground portions of the flowering plants with the second treatment occurs a week or more after contacting the above-ground portions of the flowering plants with the first treatment.

At the time of contacting the above-ground portions of the flowering plants with the first treatment, the second treatment, or both, the flowering plants may be growing in an environment with an ambient temperature of at least 50° F. or at least 75° F. An ambient temperature of the environment is typically less than 90° F. at the time of the contacting, but the ambient temperature may be higher than 90° F.

Contacting the above-ground portions of the flowering plants with the first treatment, the second treatment, or both may include misting, spraying, coating, or drenching the above-ground portions with the treatment(s). In some cases, contacting the above-ground portions of the flowering plants with the first treatment, the second treatment, or both includes dispensing the first treatment, the second treatment, or both from above the flowering plants toward the ground, or from a dispenser elevated above the ground and from one side of the flowering plants toward another side of the flowering plants. This process may be repeated such that all sides of the flowering plants or entire flowering plants are contacted with the first treatment, the second treatment, or both.

The acid in the second aqueous solution and the acid in the fourth aqueous solution may be an organic acid or an inorganic acid. The acid may be a strong acid or a weak acid, where “strong acid” refers to an acid that ionizes completely in an aqueous solution, and “weak acid” refers to all other acids. Hydrochloric acid is an example of a strong, inorganic acid. Citric acid is an example of a weak, organic acid. Other suitable acids include phosphonates, such as 2-phosphonobutane-1,2,4-tricarboxylic acid (PBTC), and 1-hydroxyethane 1,1-diphosphonic acid (HEDP). In some cases, the second aqueous solution includes two or more acids. In certain cases, the second aqueous solution includes a strong acid and a weak acid. In one example, the second aqueous solution includes hydrochloric acid and HEDP A total concentration of the acid in second aqueous solution is typically in a range of 1 wt % to 50 wt % (e.g., 5 wt % to 25 wt % of a first acid and 5 wt % to 25 wt % of a second acid). In one example, second aqueous solution includes 10 wt % to 20 wt % hydrochloric acid and 10 wt % to 20 wt % HEDP. A total concentration of acid in the second solution is sufficient to convert at least 40%, at least 50%, at least 60%, at least 70%, at least 80%, or at least 90% by weight of the chlorite in the first aqueous solution to chlorine dioxide. The acid in the fourth aqueous solution may be the same as or different than the acid in the second aqueous solution, with respect to composition and concentration.

A concentration of chlorite in the first aqueous solution, the third aqueous solution, or both is typically at least 25 parts per million by weight (ppm), in a range of 1 ppm to 200 ppm, or in a range of 1 ppm to 1000 ppm. In some cases, a concentration of the chlorite in a mixture of the first aqueous solution and the second aqueous solution, in a mixture of the third aqueous solution and the fourth aqueous solution, or in both mixtures, is at least 25 parts per million by weight (ppm), in a range of 1 ppm to 200 ppm, or in a range of 1 ppm to 1000 ppm.

A concentration of the chlorine dioxide in the first treatment, the second treatment, or both formed before, during, or after contacting of the flowering plant is at least 0.05 parts per million by weight (ppm), at least 0.25 ppm, at least 2 ppm, or at least 5 ppm, and typically less than 25 ppm or 30 ppm. In some cases, a concentration of the chlorine dioxide in the first treatment, the second treatment, or both is in a range between 0.05 ppm and 25 ppm, between 0.25 ppm and 25 ppm, between 2 ppm and 25 ppm, or between 5 ppm and 25 ppm. In certain cases, a concentration of the chlorine dioxide in the aqueous solution is in a range between 0.05 ppm and 30 ppm, between 0.25 ppm and 30 ppm, between 2 ppm and 30 ppm, or between 5 ppm and 30 ppm.

The first treatment, the second treatment, or both may also include at least one of chlorite, chlorate, and phosphonate. A total concentration of the chlorite, chlorate, and phosphonate is typically at least 25 ppm. In some cases, a concentration of the chlorite is in a range between 1 ppm and 180 ppm or 200 ppm. In certain cases, a concentration of the chlorite is greater than 200 ppm (e.g., between 200 ppm and 1000 ppm, between 200 ppm and 500 ppm, or between 200 ppm and 250 ppm).

Based on the type of flowering plant being treated, the quantity of flowering plants being treated, and the method of applying the treatment, the first aqueous solution, the second aqueous solution, or both may be applied at a rate of to 5 gallons per minute (gpm) to 5000 gpm, 5 gpm to 1000 gpm, 5 gpm to 500 gpm, 5 gpm to 150 gpm, 5 gpm to 100 gpm, 5 gpm to 50 gpm, 10 gpm to 40 gpm, or 20 gpm to 30 gpm. In some cases, the first aqueous solution, the second aqueous solution, or both may be applied at a rate of 200 gpm, 250 gpm, 500 gpm, 1000 gpm, 1500 gpm, 2000 gpm, 2500 gmp, or higher. It would be appreciated that the flow rate can be dependent, at least in part, on the number of plants being treated. In some cases, the first aqueous solution, the second aqueous solution, or both may be applied for a length of time between about 10 seconds and about 2 hours, based at least in part on the flow rate of the application.

Typical pathogens include viruses, bacteria, and fungi. In some cases, the pathogen is a bacteria, such as Erwinia amylovora, the causative agent of blight, the flowering plants are trees, such as fruit trees (e.g., apple trees, pear trees), palm trees, citrus trees, or nut trees, and a concentration of the chlorine dioxide in the first treatment, the second treatment, or both is sufficient to kill, suppress, or substantially reduce the amount of Erwinia amylovora on above-ground portions (e.g., leaves, branches, bark, trunk) of the trees, to inhibit growth of the Erwinia amylovora on the above-ground portions of the trees, or to inhibit spread of the Erwinia amylovora on each of the trees or from a first tree to a second tree. In some instances, severely infected trees can exhibit little to no symptoms of blight (e.g., weeping from the tree trunk and discolored leaves) following application of the one or more of the treatments described herein.

In some cases, the pathogen is a virus, such as Red Blotch Virus (Grablovirus or GRBav), the flowering plants are grape vines, and a concentration of the chlorine dioxide in the first treatment, the second treatment, or both is sufficient to kill, suppress, or substantially reduce the amount of the GRBav on above-ground portions (e.g., leaves, branches) of the vines, to inhibit growth of the virus on the above-ground portions of the vines, or to inhibit spread of the virus on the vines or from a first vine to a second vine.

In some cases, the pathogen is powdery mildew, the flowering plants are trees, such as fruit trees (e.g., apple trees, pear trees), palm trees, citrus trees, or nut trees, and a concentration of the chlorine dioxide in the first treatment, the second treatment, or both is sufficient to kill, suppress, or substantially reduce the amount of the powdery mildew on above-ground portions (e.g., leaves, branches) of the trees, to inhibit growth of the powdery mildew on the above-ground portions of the trees, or to inhibit spread of the powdery mildew on the trees or from a first tree to a second tree.

In some cases, the pathogen is citrus canker, the flowering plants are trees, such as citrus trees (e.g., orange trees, lemon trees), and a concentration of the chlorine dioxide in the first treatment, the second treatment, or both is sufficient to kill, suppress, or substantially reduce the amount of the citrus canker on above-ground portions (e.g., leaves, branches) of the trees, to inhibit growth of the citrus canker on the above-ground portions of the trees, or to inhibit spread of the citrus canker on the trees or from a first tree to a second tree.

Simply by way of example, when an aqueous solution as described herein is applied by spraying (e.g., via a vehicle), individual plants (e.g., trees) can receive the aqueous solution for about 10 second to about 20 seconds (e.g., application time per plant). In some instances, a sprayer is used that atomizes the solution. In some instances, a fan or a blower (e.g., a high-speed fan or blower) can be used (e.g., incorporated in the sprayer, on the vehicle) to distribute and further coat the plant. In some instances, the fan or blower is operated at a speed that moves an amount of air sufficient to liberate at least some of the ClO2 from the aqueous solution (e.g., before the aqueous solution contacts the plant, after the aqueous solution contacts the plant). Examples of suitable fans or blowers can be found, for example, on the World Wide Web at rearsmfg.com/product_powerblast_1. On the other hand, for example, when an overhead cooling/sprinkling/misting system is used to apply an aqueous solution as described herein, the application time per plant (e.g., tree) may approach one or two hours. Thus, application time per plant can vary depending, for example, on the method of application, the amount of aqueous solution applied, the frequency of application, the size and number of plants, the level of infectivity by the pathogen (on the plants being treated as well as neighboring plants), and the weather conditions.

Significantly, the aqueous solutions described herein for application to plants to inhibit pathogens rapidly degrade in UV (e.g., sunlight) light, leaving trace to undetectable amounts remaining on the plant itself or by-products of the plant (e.g., fruit, vegetables, or other raw agricultural commodities). Also importantly, it has been reported that microorganisms (e.g., pathogens) are unable to develop resistance against ClO2, since it reacts with biological thiols, which play a vital role in all living organisms (see, for example, Noszticzius et al., 2013, PLoS ONE, doi.org/10.1371/journal.pone.0079157). Thus, the methods and aqueous solutions described herein do not need to be followed up with additional or alternative pathogen-controlling agents or pesticides. On the other hand, many other pathogen-controlling measures require alternating biocides to prevent tolerance.

The methods and compositions described herein are safe for consumers of the plant or of any raw agricultural product produced therefrom primarily because UV light reduce both free chlorine and combined chlorine compounds (chloramines) into harmless, easily removable by-products. See, for example, McClean, 2009 (“Using UV for Dechlorination,” Water & Wastes Digest); and Cosson and Ernst (1994, “Photodecomposition of Chlorine Dioxide and Sodium Chlorite in Aqueous Solution by Irradiation with Ultraviolet Light,” Ind. Eng. CHem. Res., 33(6):1468-75). In addition, research has demonstrated that phosphonates also are degraded by UV light. See, for example, Lesueur et al. (2005, Chemosphere, 59(5):685-91).

The methods and compositions described herein may be applied via foliar spray or a system that delivers the aqueous solution to the above-ground portions of the plant to suppress or control pathogens on the plants. Therefore, the methods and compositions described herein will not eradicate the beneficial microbes in the soil.

In addition, it would be appreciated that further applications of an aqueous solution as described herein can be warranted after rain events or heavy dew events, regardless of the ambient temperature at the time of application and/or during the growing season.

### EXAMPLES

### Example 1

### Experiments to Inhibit Fire Blight In Vitro

Executive Summary

Of the reagents tested for bactericidal properties, ClO2 evolved from the combination of (3.1% 60% active HEDPA, 1.6% 45% active potassium hydroxide, and 35.3% water, all by weight) and (30% 60% active HEDPA, 46.8% 36% hydrochloric acid, and 23.2% water, all by weight) and the combination of (60% 25% active sodium chlorite and 40% water, all by weight) and (37.4% 36% hydrochloric acid and 62.6% water, all by weight) exhibited the greatest inhibition to E. amylovora growth at higher concentrations (e.g., 15 ppm to 25 ppm). However, at the concentrations that were provided, i.e., 2, 5, 10, 15, and 25 ppm, total inhibition of E. amylovora was not observed. At low concentrations (<5 ppm), several of the reagents promoted some amount of bacterial growth when compared to the controls (see, for example, FIGS. 3, 5, 6 and 7). Tables 1 and 2 depict measured concentration values of ClO2, Cl, and ClO2- for each reagent assayed at the time of trials as measured by the Palintest meter.

While bacterial growth inhibition was observed to the greatest degree at the highest concentrations of each reagent tested, chlorine dioxide evolved from the combination of (3.1% 60% active HEDPA, 1.6% 45% active potassium hydroxide, and 35.3% water, all by weight) and (30% 60% active HEDPA, 46.8% 36% hydrochloric acid, and 23.2% water, all by weight), and the combination of (60% 25% active sodium chlorite and 40% water, all by weight) and (37.4% 36% hydrochloric acid and 62.6% water, all by weight) inhibited growth the most. Of the premixed ClO2 and NaClO2 formulations tested, all contained less than the labeled concentrations of ClO2 when measured with the Palintest meter provided (Tables 1 and 2). Without wishing to be bound by any particular theory, the superior performance and effectiveness of the ClO2 reagents evolved from the combination of (3.1% 60% active HEDPA, 1.6% 45% active potassium hydroxide, and 35.3% water, all by weight) and (30% 60% active HEDPA, 46.8% 36% hydrochloric acid, and 23.2% water, all by weight) and the combination of (60% 25% active sodium chlorite and 40% water, all by weight) and (37.4% 36% hydrochloric acid and 62.6% water, all by weight) likely can be attributed to the higher concentrations of chlorine dioxide contained within these solutions.

Introduction

This series of experiments aimed to test the bactericidal and inhibitory properties of several different reagents at different concentrations against Erwinia amylovora, the causal agent of fire blight. Three pathovars of E. amylovora were used, Ea153, Lp101, and 87-70, all having similar colony morphology, and amylovoran exopolysaccharide exudate. The identity of one of the pathovars, Ea153, was confirmed genetically through PCR to be E. amylovora.

Methods

Reagents (HEDP and NaClO2 from CH2O Inc. (Tumwater, Wash.); NaClO2 from CH2O Inc.; ClO2 from CH2O Inc.; ClO2 rom Pace International (Wapato, Wash.); and ClO2 from CH2O Inc.) were tested at 2, 5, 10, 15 and 25 ppm for their bactericidal and inhibitory properties against E. amylovora. LB Lennox broth powder was suspended in each reagent/concentration solution at a rate of 25 mg/mL to provide nutrients for growth and division of the bacteria. This method of culturing provided the necessary nutrients for bacterial growth and division without altering the ppm concentration of the provided reagents.

200 μL of pathovar inoculum were added to 3 mL of each reagent/concentration solution and incubated for 6 hours at 28° C. and aerobically agitated on a shaker at 200 RPM. Inoculum consisted of a 1:1 ratio of 50% glycerol to bacterial culture. The bacterial culture was measured at 600 nm to have an optical density (OD) of 0.958, 0.950, and 0.972 for pathovars Ea153, Lp101 and 87-70, respectively. After 6 hours incubation, OD measurements were taken and 100 μL of each reagent/concentration solution were serially diluted to 10E-6 in 0.85% sterile saline (Reynolds, 2005, “Serial Dilution Protocols,” Am. Soc. Microbiol.). Three replicates of 100 μL of this final dilution were then plated on LB Lennox agar plates (100×15 mm) and allowed to incubate overnight at 28° C. until colony growth was visible. Colony Forming Units (CFU) calculations were made from averaged colony count numbers across the three technical replications of each trial.

Positive controls consisted of 200 μL of inoculum into 3 mL of pure LB Lennox broth (25 mg/mL) incubated for 6 hours at 28° C. aerobically agitated on shaker at 200 RPM, serially diluted to 10E-6 and plated on LB Lennox agar plates (100×15 mm).

Negative controls consisted of 3 mL of each reagent/concentration/LB solution without bacterial inoculation incubated for 6 hours at 28° C. aerobically agitated on a shaker at 200 RPM plated on LB Lennox agar plates (100×15 mm) without dilution.

Results

Correlation between optical density observed at 600 nm (0D600) and CFU when the same reagent/concentration solution was plated and allowed to incubate (FIG. 1). This correlation allows OD600 measurements to corroborate CFU count data.

Three pathovars of E. amylovora, the causal agent of fire blight, cultured in each reagent were assayed (FIGS. 2-7). These figures depict bactericidal response to LB broth powder suspended in each reagent concentration. FIG. 8 depicts E. amylovora response when grown in LB broth powder suspended in sterile ddH2O, and these data were used as the experimental positive control. The figures show that, with increasing concentration of reagent, there is a general trend in bacterial growth inhibition.

TABLE 1
Reagent concentrations at time of trial measured using a Palintest meter (mg/L)

| Labeled | HEDP | | | NaClO2 (CH2O) | | | NaClO2 (CH2O) | | | ClO2 | | |
|---|---|---|---|---|---|---|---|---|---|---|---|---|
| Concentration | ClO2 | Cl | ClO2— | ClO2 | Cl | ClO2— | ClO2 | Cl | ClO2— | ClO2 | Cl | ClO2— |
| 2 ppm | <0.02 | <0.02 | <0.02 | <0.02 | <0.02 | 1.08 | <0.02 | <0.02 | 1.03 | <0.02 | <0.02 | 0.49 |
| 5 ppm | <0.02 | <0.02 | <0.02 | <0.02 | <0.02 | 3.4 | <0.02 | <0.02 | 3.6 | <0.02 | <0.02 | 1.52 |
| 10 ppm | <0.02 | <0.02 | <0.02 | <0.02 | <0.02 | 6.5 | <0.02 | <0.02 | 6 | <0.02 | 0.18 | 2.9 |
| 15 ppm | <0.02 | <0.02 | <0.02 | <0.02 | <0.02 | 10.1 | <0.02 | <0.02 | 10.9 | <0.02 | 0.34 | 4.5 |
| 25 ppm | <0.02 | <0.02 | <0.02 | <0.02 | <0.02 | 17 | 0.15 | <0.02 | 17.1 | <0.02 | 0.27 | 5.5 |

TABLE 2
ClO2 concentrations from different chemical combinations
at time of trials measured using a Palintest meter

| | | (30% (by weight) 60% active |
|---|---|---|
| | | HEDPA, 46.8% (by weight) 36% |
| | (60% (by weight) 25% | hydrochloric acid, 23.2% (by |
| | active sodium chlorite, | weight) water) & (3.1% (by |
| | 40% (by weight) water) | weight) 60% active HEDPA, |
| | & (37.4% (by weight) 36% | 1.6% (by weight) 45% active |
| | hydrochloric acid, 62.6% | potassium hydroxide, 35.3% |
| | (by weight) water) | (by weight) water) |
| Desired | Real | Real |
| 2 | 2.69 | 2.22 |
| 5 | 5.68 | 6.01 |
| 10 | 9.38 | 8.52 |
| 15 | 15.2 | 15.7 |
| 25 | 26.1 | 27.1 |

### Example 2

### Field Experiments in Apple Orchards

### Orchard #1

Organic Fuji apple trees at Orchard #1 were treated with ClO2, which was generated by combining two precursor chemicals (37.4% 36% hydrochloric acid, 8% citric acid, and 54.6% water, all by weight) and (3.1% 60% active HEDPA, 1.6% 45% active potassium hydroxide, and 35.3% water, all by weight) at a ratio of 1:1 using a chlorine dioxide generator system. The treatments were applied using a sprayer (also referred to as a tractor sprayer or a speed sprayer). The air temperature was 70° F. on day 1 of the treatments and 60° F. on day 2 of the treatments.

Day 1 Test Logs:

Test #1—ClO2 PPM (23.5); Total Oxidant PPM (38); Phosphonate PO4 PPM (12.3)

Test #2—ClO2 PPM (20.0); Total Oxidant PPM (39); Phosphonate PO4 PPM (11.5)

Test #3—ClO2 PPM (19.8); Total Oxidant PPM (39); Phosphonate PO4 PPM (11.6)

Day 2 Test Logs:

Test #1—ClO2 PPM (40.0); Total Oxidant PPM (41); Phosphonate PO4 PPM (13.5)

Test #2—ClO2 PPM (22.0); Total Oxidant PPM (39); Phosphonate PO4 PPM (12.5)

Test #3—ClO2 PPM (14.0); Total Oxidant PPM (38); Phosphonate PO4 PPM (11.4)

### Orchard #2

Ambrosia apple trees at Orchard #2 were treated with (30% 60% active HEDPA, 46.8% 36% hydrochloric acid, and 23.2% water, all by weight) and (3.1% 60% active HEDPA, 1.6% 45% active potassium hydroxide, and 35.3% water, all by weight) at a ratio of 1:1. The treatments were applied using overhead systems with a flow rate of 180 GPM and a chemical injection system set to operate at 300 SPM. The air temperature was 75° F. on the day of application.

Test Logs:

Test #1—ClO2 PPM (18.0); Total Oxidant PPM (54); Phosphonate PO4 PPM (20+)

Test #2—ClO2 PPM (16.0); Total Oxidant PPM (52); Phosphonate PO4 PPM (20+)

Test #3—ClO2 PPM (16.0); Total Oxidant PPM (52); Phosphonate PO4 PPM (20+)

### Orchard #3

Fuji apple trees at Orchard #3 were treated with (30% 60% active HEDPA, 46.8% 36% hydrochloric acid, and 23.2% water, all by weight) and (3.1% 60% active HEDPA, 1.6% 45% active potassium hydroxide, and 35.3% water, all by weight) at a ratio of 1:1. The treatment was applied using overhead sprayers and ground sprayers with a flow rate of 200 GPM and a chemical injection system set to operate at 360 SPM. The air temperature was 80° F. on the day of application. 18 acres in total were treated.

Block #3 & 13 (Overhead Cooling System)

Test #1—ClO2 PPM (29); Total Oxidant PPM (42); Phosphonate PO4 PPM (130.1) (First Row)

Test #2—ClO2 PPM (21); Total Oxidant PPM (32); Phosphonate PO4 PPM (115.0) (Middle Row)

Test #3—ClO2 PPM (22); Total Oxidant PPM (32); Phosphonate PO4 PPM (118.0) (Last Row)

Block #1 (Overhead Cooling System)

Test #1—ClO2 PPM (8); Total Oxidant PPM (25); Phosphonate PO4 PPM (98.0) (First Row)

Test #2—ClO2 PPM (17); Total Oxidant PPM (32); Phosphonate PO4 PPM (114.0) (Middle Row)

Test #3—ClO2 PPM (16); Total Oxidant PPM (32); Phosphonate PO4 PPM (11.4) (Last Row)

Block #1 (Ground Sprinkler)

Test#1—ClO2 PPM (12); Total Oxidant PPM (21); Phosphonate PO4 PPM (99.0) (First Row)

Test#2—ClO2 PPM (9); Total Oxidant PPM (9); Phosphonate PO4 PPM (86.0) (Middle Row)

Test#3—ClO2 PPM (8.5); Total Oxidant PPM (21); Phosphonate PO4 PPM (90.0)

### Orchard #4

Apple trees at Orchard #4 already infected with Fire Blight were treated with ClO2 (4.4 ClO2 ppm from a well head (24 mix oxidants) or 3.61 ClO2 ppm from a sprinkler (24 mix oxidants)) and a chemical treatment (3.1% 60% active HEDPA, 1.6% 45% active potassium hydroxide, and 35.3% water, all by weight) and (30% 60% active HEDPA, 46.8% 36% hydrochloric acid, and 23.2% water, all by weight). The treatment was applied over a 4 hour period using a pump with a flow rate of 500 GPM. 53 rows (about 7-8 acres) were treated.

### Orchard #5

The solution applied was tested following a trial at Orchard #5. 14.6 ppm of ClO2 was identified and 4.5 ppm of phosphonate were identified. Phosphonate levels were determined via UV digestion to convert to orthophosphate.

### Orchard #6

Apple trees at Orchard #6 infected with Jack Frost Blight (FIGS. 9A, 9B and 9C) were treated with 2 ppm (FIG. 10A), 5 ppm, 10 ppm (FIG. 10B) or 25 ppm (FIG. 10C) of ClO2. While blight was easily found in untreated areas of the block, only 2 strikes were found in the 2 ppm test area, no strikes were found in the 5 ppm area, 1 strike was found in the 10 ppm area, and 1 strike was found at the very end of the 25 ppm area (it is unclear whether that part of the area was actually treated or treated fully).

### Orchard #7

Gala apple trees seriously infected with blight were treated with (3.1% 60% active HEDPA, 1.6% 45% active potassium hydroxide, 35.3% water, all by weight) and (3.1% 60% active HEDPA, 1.6% 25% active sodium chlorite, and 35.3% water, all by weight) applied through overhead sprinklers. Following treatment, the blight was fully dried up, with no ooze present. The blight at this orchard was fully neutralized with no sign of post treatment inoculation. FIG. 11A shows leaves pre-treatment, while FIGS. 11B and 11C show clean, healthy and extremely green leaves after treatment.

### Example 3

### Field Experiments in Grape Vinyards

Field trials were performed on grape vines infected with Red Blotch Virus (Grablovirus or GRBav).

Grape vines were treated with (36% 36% hydrochloric acid, 8% 60% active HEDPA, 0.5% 120 grain vinegar, 0.5% 85% phosphoric acid, and 55% water, all by weight) and (3.1% 60% active HEDPA, 1.6% 45% active potassium hydroxide, 35.3% water, all by weight). ClO2 was made using a CH2O-ClO2 generator, and applied using an orchard sprayer. 200 gallons of treated water was applied per acre, and the treated water contained 15 ppm ClO2. The air temperature was 70° F.-90° F. on the days of application.

Half of the treated rows were pruned with shears dipped in water containing 30 to 50 ppm chlorine bleach. The other half of the treated rows were pruned with shears dipped in water treated with 15 ppm ClO2.Rows treated with ClO2 and pruned with ClO2-sanitized shears showed approximately 85% less GRBav than the untreated control area, while rows that were treated with ClO2 and pruned with shears dipped in chlorine bleach had approximately 75% less virus than the untreated control area. Therefore, treatment with ClO2 resulted in a 75-85% reduction in the amount of virus on the grape plants.

### Example 4

### Additional Field Experiments

An apple and pear tree orchard infected with Erwinia amylovora (“Fire Blight”) was treated with 2 ppm, 5 ppm, 10 ppm, and 25 ppm ClO2 as described herein. Previous unsuccessful treatments included foliar medications and metal (Cu) suspended in oil, and Tetramyacin and Oxytetracycline application. These are very expensive medication option(s) that are becoming obsolete w/resistance.

The treatment protocol at this orchard included a three step approach: a) irrigation water; b) topical application before first bloom (e.g., begin topical treatment before primary bloom event and all the way through second blooming event); and c) ooze treatment/vector suppression. Given the timing of this trial, only step C is relevant.

Trees were sprayed when the temperature reached a minimum of 50° F. The temperature for treating bacterial ooze should be between 75-90° F., with highest “safe” rates of ClO2 used to prevent spread through insect and pollination activity. The residual phosphorus (from phosphonates) should have lasting protection properties even days after a topical application.

Repeating the applications should be considered a priority. Lower doses with increased applications can be more effective when compared to higher doses with fewer applications (e.g., maintenance dose vs. infected (“hot”) dose).

Rows were marked based on the concentration of ClO2 to be applied. Each concentration rate was applied slowly over four rows of trees. Two rows of trees were left untreated between each of the treated rows to prevent drift. After an application at a particular concentration was complete, the pump speed was increased or decreased to adjust the ClO2 concentration for the next application.

One new blight strike was observed in the 2 ppm zone. Absolutely no new blight was found in any of the remaining test zones. Thus, ClO2 concentrations at 5 ppm (or more) have proven to be effective means of disease control.

| | nozzles @ | | 50 ft tubing | 50 ft tubing |
|---|---|---|---|---|
| | 200 | w/o | w/nozzle w/ | w/nozzle w/o |
| | gal/Acre | nozzles | spin-plates | spin-plates |
| T. Ox | 180 | 100 | 12 | 25 |
| [ClO2] | 0.25 | 9.5 | 1.45 | 5.7 |
| ppm | | | | |
| pH | 7.3 | 7.1 | 7 | 6.96 |
| EC | 755 | 760 | 728 | 732 |
| ORP | | | 706 | 715 |
| SPM | 180 | 180 | 180 | 180 |
| GPM | 15 | 15 | 15 | 15 |
| Notes: | spm was so | [ClO2] | extra tubing | Extra tubing |
| | high that | increased | helped reaction | without the |
| | precursors | but was | but spin-plates | spin-plates |
| | were not | coming out | are making | inside nozzles |
| | able to | like garden | droplet size | seems to be |
| | react | hose, stream | too small, | one of the |
| | | was too | ClO2 coming | “sweet spots” |
| | | large | out of solution. | |

| | Control - | 2 ppm | 5 ppm |
|---|---|---|---|
| | 0 ppm | zone | zone |
| T. Ox | 0 | 12 | 25 |
| [ClO2] | 0.25 | 1.3 | 8.1 |
| ppm | | | |
| pH | 7.9 | 7.71 | 6.95 |
| EC | 755 | 738 | 784 |
| ORP | | 626 | 740 |
| SPM | 180 | 180 | 180 |
| GPM | 15 | 15 | 15 |

| | Control - | 2 ppm | 5 ppm | 10 ppm | 25 ppm |
|---|---|---|---|---|---|
| | 0 ppm | zone | zone | zone | zone |
| T. Ox (ppm) | 0 | 25 | 47 | 51 | 74 |
| [ClO2] | 00 | 4.6 | 7.44 | 7.8 | 46.3 |
| (ppm) | | | | | |
| SPM | 0 | 20 | 12 | 22 | 60 |
| Stroke % | 100 | 100 | 50 | 50 | 50 |

### Example 5

### Measurement of Chlorite

One of the solutions applied to plants contained a combination of 16.8% active HCL, 18% active HEDP, and water. Removal of residual ClO2 from the mixed oxidants or total oxidants determines the amount of chlorite. Alternately, the total amount of oxidants minus the ClO2 can be used to determine the amount of chlorite. It would be appreciated, however, that ClO2 levels can be in flux during field testing. The following is a representative example.

Total oxidant=mixed oxidant

Total oxidant as tested by total oxidant test=4.0 ppm

Chlorine dioxide as tested by Palin Meter=1.0 ppm

ClO2 residual/0.38 (contribution to total oxidant test)=1.0/0.38=2.63

Total oxidant−(ClO2 residual/0.38)=other oxidants=4.0−2.63=1.37 ppm

Assume other oxidants are sodium chlorite

Total oxidant×0.64=sodium chlorite, so 1.37 ppm×0.64=0.88 ppm sodium chlorite

### Example 6

### Chlorine Measurements

Tests were performed to evaluate for chlorine dioxide, free chlorine, and chlorite concentration following application of ClO2 to an apple orchard. Measurements were made at several points along the path of the spray to determine residual ClO2.

All testing was performed on the ChlordioX Plus instrument. Before testing, the check standards were analyzed to ensure instrument functionality. The CDX sensors used were from Batch 00795 and the CS sensors were from Batch 00793. The sensor batch numbers were checked to match the calibration numbers on the instrument.

Testing occurred under dry conditions with temperatures ranging from approximately 40° F. to 60° F.

Test 1

ClO2 concentration was set-up at the sprayer point similar to what would be used in application. The ClO2 concentration was tested immediately after coming out of the sprayer and tested until the proper concentration had been reached and remained stable. The sample coming out of the sprayer was collected first into a glass jar and immediately transferred into an amber bottle. The necessary volume was then added into the instrument's sample container and tested. This took approximately 20 minutes with the sprayer turned on.

During the last 5 minutes of applying the ClO2 to the trees, a “Sprayer” sample was obtained as well as another sample collected at the point below the tree branches close to the ground (“Ground” sample). The samples were collected into a plastic tray, and then transferred into amber bottles.

| Sample | ClO2 (ppm) | Free Chlorine (ppm) | Chlorite (ppm) |
|---|---|---|---|
| Sprayer | 17.8 | 0.10 | 4.3 |
| Ground | 0.09 | 0.36 | 4.5 |

Test 2

The 2nd test required refilling the water tank on the sprayer and again reaching a stabile ClO2 concentration. The sprayer initially had different ClO2 levels coming out of the left side of the sprayer vs the right side of the sprayer, but after approximately 20 minutes, it stabilized and testing began.

The same sample points were gathered and a third point was also gathered, directly below the tree branches where the spray was dripping off (“Tree drip” sample). A new set of trees were used for this round of testing.

| Sample | ClO2 (ppm) | Free Chlorine (ppm) | Chlorite (ppm) |
|---|---|---|---|
| Sprayer | 18.3 | 0.16 | 1.9 |
| Ground | 0.14 | 0.05 | 4.3 |
| Tree Drip | 0.13 | <0.02 | <0.02 |

Only a few implementations are described and illustrated. Variations, enhancements and improvements of the described implementations and other implementations can be made based on what is described and illustrated in this document.

What is claimed is:

1. A method for treating plants, the method comprising:
in a growing season, contacting above-ground portions of flowering plants with an aqueous solution comprising a plant pathogen-inhibiting agent, wherein the plant pathogen-inhibiting agent comprises at least one of chlorite, chlorate, chlorine dioxide, or a phosphonate, and a total concentration of the plant pathogen-inhibiting agent in the aqueous solution is sufficient to:
kill, suppress, or substantially reduce the amount of plant pathogens on the above-ground portions of the flowering plants,
inhibit growth of plant pathogens on the above-ground portions of the flowering plants, or
inhibit spread of plant pathogens on each of the flowering plants or from a first one of the flowering plants to a second one of the flowering plants.

2. The method of claim 1, wherein the pathogen-inhibiting agent comprises, consists of, or consists essentially of chlorite.

3. The method of claim 2, wherein a concentration of the chlorite in the aqueous solution is at least 25 parts per million by weight.

4. The method of claim 2, wherein a concentration of the chlorite in the aqueous solution is in a range of 1 part per million by weight to 200 parts per million by weight.

5. The method of claim 2, wherein a concentration of the chlorite in the aqueous solution is in a range of 1 part per million by weight to 1000 parts per million by weight.

6. The method of claim 1, wherein the pathogen-inhibiting agent comprises, consists of, or consists essentially of a phosphonate.

7. The method of claim 6, wherein the phosphonate comprises at least one of phosphonobutane-1,2,4-tricarboxylic acid and 1-hydroxyethane 1,1-diphosphonic acid.

8. The method of claim 6, wherein a concentration of the phosphonate in the aqueous solution is at least 25 parts per million by weight.

9. The method of claim 6, wherein a concentration of the phosphonate is in a range of 0.1 parts per million by weight to 50 parts per million by weight.

10. The method of claim 1, wherein the pathogen-inhibiting agent comprises, consists of, or consists essentially of chlorite and a phosphonate.

11. The method of claim 1, wherein the pathogen-inhibiting agent comprises, consists of, or consists essentially of chlorine dioxide.

12. The method of claim 1, wherein a concentration of the chlorine dioxide in the aqueous solution is at least 0.05 parts per million by weight.

13. The method of claim 12, wherein a concentration of chlorine dioxide in the aqueous solution is at least 2 parts per million by weight.

14. The method of claim 13, wherein a concentration of chlorine dioxide in the aqueous solution is at least 5 parts per million by weight.

15. The method of claim 13, wherein a concentration of chlorine dioxide in the aqueous solution is 25 parts per million by weight or less.

16. The method of claim 13, wherein a concentration of chlorine dioxide in the aqueous solution is 30 parts per million by weight or less.

17. The method of claim 1, wherein the pathogen-inhibiting agent comprises, consists of, or consists essentially of chlorine dioxide and chlorite.

18. The method of claim 1, wherein the pathogen-inhibiting agent comprises, consists of, or consists essentially of chlorine dioxide, chlorite, and a phosphonate. The method of claim 1, wherein the pathogen-inhibiting agent comprises, consists of, or consists essentially of a phosphonate.

20. The method of claim 19, wherein the phosphonate comprises at least one of phosphonobutane-1,2,4-tricarboxylic acid and 1-hydroxyethane 1,1-diphosphonic acid.

21. The method of claim 1, wherein the pathogen-inhibiting agent comprises, consists of, or consists essentially of chlorite, chlorate, and chlorine dioxide.

22. The method of claim 12, wherein a total concentration of the chlorite, the chlorate, and the chlorine dioxide in the aqueous solution is at least 25 parts per million by weight.

23. The method of claim 12, wherein a concentration of chlorite, the chlorate, and the chlorine dioxide in the aqueous solution is in a range of 1 part per million by weight to 200 parts per million by weight.

24. The method of claim 12, wherein a concentration of chlorite, the chlorate, and the chlorine dioxide in the aqueous solution is in a range of 1 part per million by weight to 200 parts per million by weight.

25. The method of claim 12, wherein a concentration of chlorite, the chlorate, and the chlorine dioxide in the aqueous solution is in a range of 1 part per million by weight to 1000 parts per million by weight.

26. The method of claim 1, wherein contacting the above-ground portions of the flowering plants comprises contacting leaves of the flowering plants.

27. The method of claim 1, wherein the flowering plants are trees, and contacting the above-ground portions of the flowering plants comprises contacting at least one of the branches, trunk, and bark of the tree.

28. The method of claim 1, wherein contacting the above-ground portions of the flowering plants with the aqueous solution occurs before blooms are formed on the flowering plants.

29. The method of claim 1, wherein the aqueous solution is a first aqueous solution and further comprising, in the growing season, contacting the above-ground portions of the flowering plants with a second aqueous solution comprising a second pathogen-inhibiting agent, wherein a concentration of the second pathogen-inhibiting agent in the second aqueous solution is sufficient to kill, suppress, or substantially reduce the amount of pathogens on the flowering plants.

30. The method of claim 29, wherein the second pathogen-inhibiting agent comprises, consists of, or consists essentially of chlorite.

31. The method of claim 29, wherein the second pathogen-inhibiting agent comprises, consists of, or consists essentially of a phosphonate.

32. The method of claim 31, wherein the phosphonate comprises at least one of phosphonobutane-1,2,4-tricarboxylic acid and 1-hydroxyethane 1,1-diphosphonic acid.

33. The method of claim 29, wherein the second pathogen-inhibiting agent comprises, consists of, or consists essentially of, chlorite and a phosphonate.

34. The method of claim 29, wherein the second pathogen-inhibiting agent comprises, consists of, or consists essentially of chlorine dioxide.

35. The method of claim 29, wherein the second pathogen-inhibiting agent comprises, consists of, or consists essentially of chlorine dioxide and chlorite.

36. The method of claim 29, wherein the second pathogen-inhibiting agent comprises, consists of, or consists essentially of, chlorine dioxide, chlorite, and a phosphonate.

37. The method of claim 29, wherein contacting the above-ground portions of the flowering plants with the second aqueous solution occurs after blooms are formed on the flowering plants.

38. The method of claim 29, wherein contacting the above-ground portions of the flowering plants with the second aqueous solution occurs at least five days after contacting the above-ground portions of the flowering plants with the first aqueous solution.

39. The method of claim 1, wherein the flowering plants are growing in an environment having an ambient temperature of at least 50° F. at the time of the contacting.

40. The method of claim 1, wherein the flowering plants are growing in an environment having an ambient temperature of at least 75° F. at the time of the contacting.

41. The method of claim 1, wherein the flowering plants are in an environment having an ambient temperature of less than 90° F. at the time of the contacting.

42. The method of claim 1, wherein contacting the above-ground portions of the flowering plants with the aqueous solution comprises misting the above-ground portions with the aqueous solution.

43. The method of claim 1, wherein contacting the above-ground portions of the flowering plants with the aqueous solution comprises coating the above-ground portions with the aqueous solution.

44. The method of claim 1, wherein contacting the above-ground portions of the flowering plants with the aqueous solution comprises drenching the flowering plants with the aqueous solution.

45. The method of claim 1, wherein contacting the above-ground portions of the flowering plants with the aqueous solution comprises dispensing the aqueous solution from above the flowering plants toward the ground.

46. The method of claim 1, wherein contacting the above-ground portions of the flowering plants with the aqueous solution comprises dispensing the aqueous solution from a dispenser elevated above the ground and from one side of the flowering plants toward another side of the flowering plants.

47. The method of claim 1, wherein the pathogen comprises a species of bacteria.

48. The method of claim 35, wherein the bacteria comprises Erwinia amylovora.

49. The method of claim 1, wherein the method for treating plants is a foliar treatment method.

50. A method for treating plants, the method comprising:
in a growing season, contacting above-ground portions of flowering plants with a first aqueous solution and a second aqueous solution or a mixture thereof, wherein the first aqueous solution comprises chlorite, the second aqueous solution comprises an acid, and the mixture of the first aqueous solution and the second aqueous solution comprises chlorine dioxide in a concentration sufficient to:
kill, suppress, or substantially reduce the amount of pathogens on the above-ground portions of the flowering plants,
inhibit growth of pathogens on the above-ground portions of the flowering plants, or
inhibit spread of pathogens on each of the flowering plants or from a first one of the flowering plants to a second one of the flowering plants.

51. The method of claim 50, wherein contacting the above-ground portions of the flowering plants comprises contacting leaves of the flowering plants.

52. The method of claim 50, wherein the flowering plants are trees, and contacting the above-ground portions of the flowering plants comprises contacting at least one of the branches, trunk, and bark of the tree.

53. The method of claim 50, wherein contacting the above-ground portions of the flowering plants with the first aqueous solution, the second aqueous solution, or the mixture thereof occurs before blooms are formed on the flowering plant.

54. The method of claim 50, further comprising, in the growing season, contacting the above-ground portions of the flowering plants with a third aqueous solution and a fourth aqueous solution or a mixture thereof, wherein the third aqueous solution comprises chlorite, the fourth aqueous solution comprises an acid, and the mixture of the third aqueous solution and the fourth aqueous solution comprises chlorine dioxide in a concentration sufficient to kill, suppress, or substantially reduce the amount of pathogens on the above-ground portions of the flowering plants.

55. The method of claim 54, wherein contacting the above-ground portions of the flowering plants with the third aqueous solution, the fourth aqueous solution, or the mixture thereof occurs after blooms are formed on the flowering plants.

56. The method of claim 54, wherein contacting the above-ground portions of the flowering plants with the third aqueous solution, the fourth aqueous solution, or the mixture thereof occurs at least five days after contacting the above-ground portions of the flowering plants with the first aqueous solution, the second aqueous solution, or the mixture thereof.

57. The method of claim 50, wherein contacting the above-ground portions of the flowering plants with the first aqueous solution and the second aqueous solution comprises dispensing the first aqueous solution and the second aqueous solution simultaneously.

58. The method of claim 50, wherein a concentration of chlorine dioxide in the mixture is at least 0.05 parts per million by weight.

59. The method of claim 50, wherein a concentration of chlorine dioxide in the mixture is at least 0.25 parts per million by weight.

60. The method of claim 50, wherein a concentration of chlorine dioxide in the mixture is at least 2 parts per million by weight.

61. The method of claim 60, wherein a concentration of chlorine dioxide in the mixture is at least 5 parts per million by weight.

62. The method of claim 60, wherein a concentration of chlorine dioxide in the mixture is 25 parts per million by weight or less.

63. The method of claim 60, wherein a concentration of chlorine dioxide in the mixture is 30 parts per million by weight or less.

64. The method of claim 60, wherein a total concentration of chlorine dioxide, chlorite, and chlorate in the mixture is at least 25 parts per million by weight.

65. The method of claim 50, wherein a concentration of chlorite in the mixture of the first aqueous solution and the second aqueous solution is in a range of 1 part per million by weight to 180 parts per million by weight or 200 parts per million by weight.

66. The method of claim 50, wherein a concentration of the acid in second aqueous solution is sufficient to convert at least 40%, at least 50%, at least 60%, at least 70%, at least 80%, or at least 90% by weight of the chlorite in the first aqueous solution to chlorine dioxide.

67. The method of claim 50, wherein the acid comprises an organic acid, an inorganic acid, or both.

68. The method of claim 50, wherein the acid comprises a strong acid, a weak acid, or both.

69. The method of claim 50, wherein the acid comprises a phosphonate.

70. The method of claim 50, wherein the acid comprises at least one of hydrochloric acid, citric acid, 2-phosphonobutane-1,2,4-tricarboxylic acid, and 1-hydroxyethane 1,1-diphosphonic acid.

71. A method of applying an aqueous solution of ClO2 to a plant, comprising:
spraying (or atomizing) the plant with an aqueous solution of ClO2 in the presence of a fan or a blower, wherein the fan or the blower moves an amount of air sufficient to liberate at least some of the ClO2 from the aqueous solution.

72. The method of claim 71, wherein the liberation occurs before the aqueous solution contacts the plant.

73. The method of claim 71, wherein the liberation occurs after the aqueous solution contacts the plant.

74. The method of claim 71, wherein at least 10% of the ClO2 is liberated from the aqueous solution.
